(19) United States
(12) Patent Application Publication
(10) Pub. No.: US 2006/0168931 A1
(43) Pub. Date: Aug. 3, 2006

(54) Driveline arrangement rotary side-pull mower-conditioner

(75) Inventor: Roger Dale Stephenson, Ottumwa, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/049,162

(22) Filed: Feb. 2, 2005

(51) Int. Cl. A01D 34/64

(52) U.S. Cl. 56/14.7

(57) ABSTRACT

A side-pull mower-conditioner includes a mobile frame from which a header is suspended and to which a swing tongue is connected for coupling the frame to a towing tractor. The header includes a cutterbar and crop conditioner that are coupled to a gearbox mounted to a top, left front location of the header and including an input shaft coupled to a slip clutch, which in turn is coupled to a driveline adapted for being coupled to a power take-off of the tractor. As considered from front to rear, the driveline includes a front telescopic shaft, front and rear pedestal shafts mounted to the mower-conditioner tongue, and a rear telescopic shaft. All of the connections between the various shafts, and between the rear telescopic shaft and the slip clutch are effected by single cardan joints, and the shafting locations and angles are chosen so that a smooth delivery of power takes place.

### FIELD OF THE INVENTION

The present invention relates to a side-pull mower-conditioner, and more specifically relates to a driveline for such a mower-conditioner.

### BACKGROUND OF THE INVENTION

Rotary side-pull mower-conditioners typically use a gearbox mounted over the left end of the cutterbar with drivelines running from the tractor power take-off (pto) shaft to this gearbox. The common arrangement utilizes three main drive line components, namely a first telescoping drive shaft, a fixed pedestal shaft and a second telescoping drive shaft.

The first telescoping drive shaft is used between the tractor pto shaft and the fixed pedestal shaft, which is carried by the tongue of the mower-conditioner. Depending on hitch geometry, this first telescoping drive may be coupled using single cardan joints, constant velocity (cv) joints, or a combination of the two.

The pedestal shaft is normally disposed so that it makes a small angle relative to the direction of travel. The angle of the shaft is designed to minimize the accelerations of the overall drive train.

The second telescoping drive shaft is coupled between the pedestal shaft and the platform gearbox. This drive shaft typically has at least one constant velocity joint to minimize accelerations.

A drawback of these known driveline arrangements is that they are relatively expensive.

### SUMMARY OF THE INVENTION

According to the present invention, there is provided a rotary side-pull mower-conditioner having an improved driveline arrangement for coupling the power take-off of the towing tractor to the gearbox located above, and coupled to a left-hand end cutter disc of the cutterbar.

An object of the invention is to provide an economical driveline arrangement which operates without excessive accelerations.

The object of the invention is accomplished by a driveline arrangement including four separate shaft sections and five single cardan joints coupling the sections to each other and to the tractor pto and the gearbox that is coupled for driving the rotary cutterbar.

Specifically, the driveline arrangement of the present invention includes a first telescoping drive shaft, quite similar to that of the prior art, having a front end coupled to the tractor pto by a first single cardan joint and having a rear end coupled to a front end of first pedestal shaft by a second single cardan joint. The rear end of the first pedestal shaft is coupled to a front end of a second pedestal shaft by a third single cardan joint, and the rear end of the second pedestal shaft is coupled, as by a fourth single cardan joint, with a first end of a second telescopic drive shaft, with a second end of the second telescopic shaft being coupled to the gear box by a fifth single cardan joint.

The first pedestal shaft, is similar to the ones of the prior art, and is placed such that it allows cancellation of the angles of the first and second single cardan joints, as the towing tractor goes through a turn, on flat ground, relative to the tongue. The second fixed pedestal shaft is added to get the drive pointed toward the gearbox while canceling the angles of the third and fourth single cardan joints.

The second telescoping drive shaft is designed so as to keep the angle of the fifth single cardan joint near zero for operation with the tongue positioned in the normal operation position. If desired, the fifth single cardan joint may be replaced with a constant velocity joint to allow machine operation with any tongue position.

A second configuration of the driveline arrangement utilizes six single cardan joints and is similar to the first-described driveline arrangement, except for the provision of a third fixed pedestal shaft coupled between the second fixed pedestal shaft and a second telescoping drive shaft that is coupled to the gear box by the sixth single cardan joint. The third fixed pedestal shaft is placed so that the angles of the fifth and sixth single cardan joints cancel each other. The six joint drive line arrangement would be used in cases where gearbox placement and input shaft angle make it impractical to have the joint angle at the gearbox near zero.

### BRIEF DESCRIPTION OF THE DRAWINGS

FIG. 1 is schematic top view of a rotary side-pull mower-conditioner shown coupled to a towing tractor.

FIG. 2 is a left side view of the side-pull mower conditioner shown in FIG. 1.

FIG. 3 is a schematic representation of a driveline portion incorporating a typical single cardan joint.

### DESCRIPTION OF THE PREFERRED EMBODIMENT

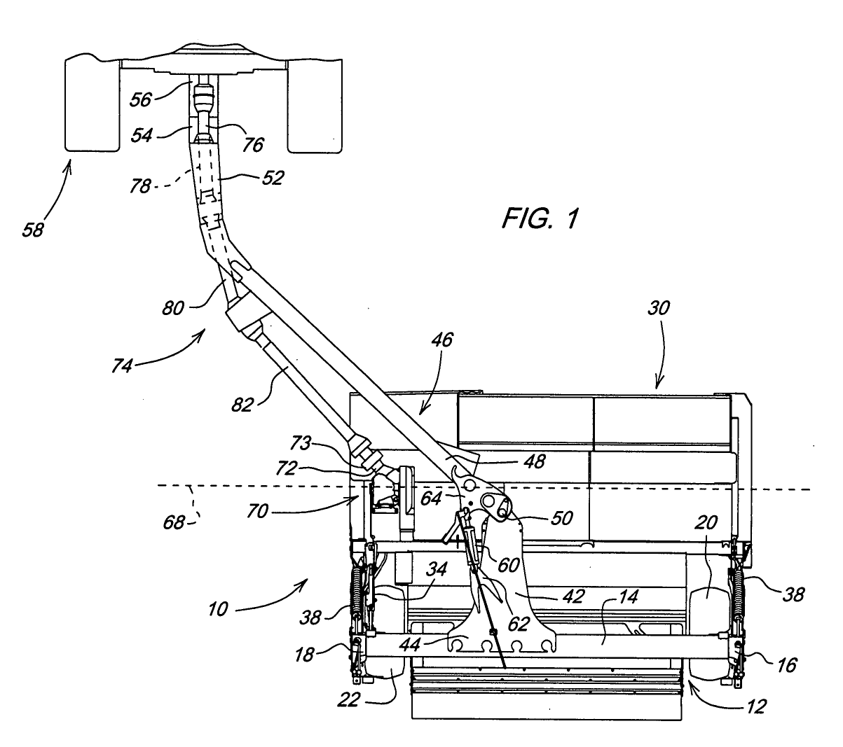

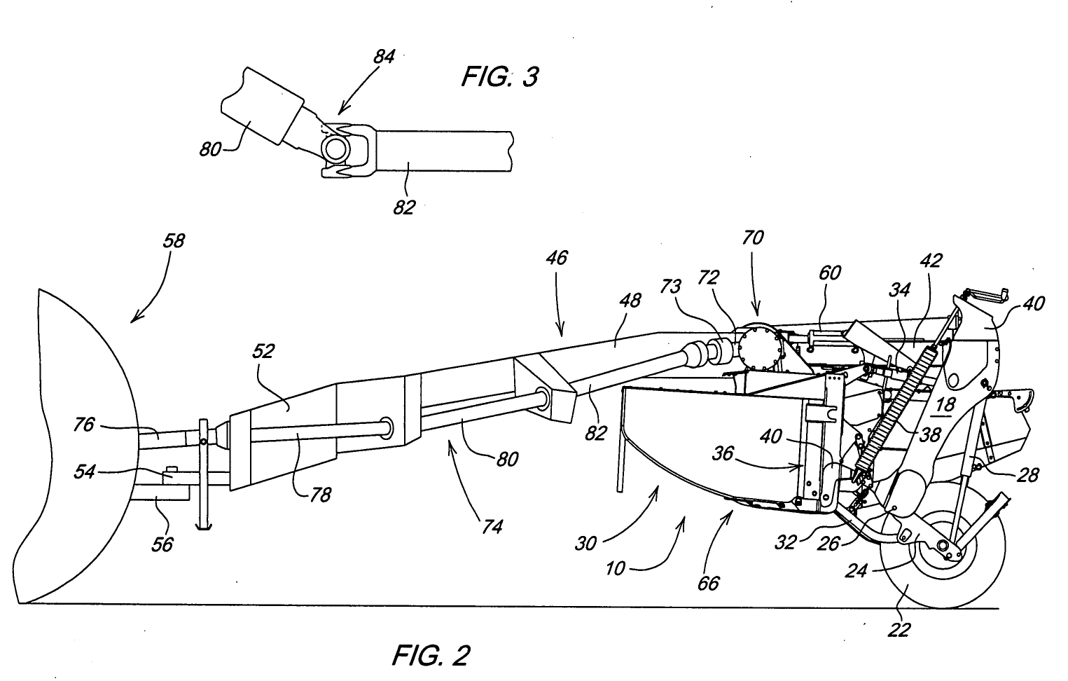

Referring now to FIGS. 1 and 2, there is shown a rotary side-pull mower-conditioner 10, including an inverted U-shaped carrier frame 12 comprising a transverse beam 14 extending between, and joined to, right- and left-hand depending legs 16 and 18, respectively. Right- and left-hand ground wheels 20 and 22 are respectively mounted to the legs 16 and 18, with only the structure for mounting the left-hand wheel 22 being clearly visible.

Specifically, a trailing wheel support arm 24 has a rear region, which carries an inwardly projecting axle (not visible) on which the wheel 22 is rotatably mounted, and has a forward end pivotally coupled to a lower region of the left-hand leg 18 by a transverse pin 26. Coupled between an upper rear region of the leg 18 and the wheel support arm 24 is an extensible and retractable hydraulic actuator 28. The right-hand wheel 20 is mounted to the right-hand leg 16 in a similar manner.

A header or platform 30 is suspended from the carrier frame 12 by a linkage including a transversely spaced pair of lower links 32, and an upper link 34. The pair of lower links 32 are respectively located in fore-and-aft alignment with the wheel support arms 24 and have forward ends pivotally coupled to lower rear regions of a header frame 36 and have rear ends pivotally coupled to middle regions of the wheel support arms 24. The upper link 34 is in the form of a turnbuckle which extends fore-and-aft and has a forward end pivotally attached to a bracket fixed to an upper rear region of the header frame 36, and has a rear end pivotally coupled to an inner forward location of an upper region of the left-hand leg 18. A pair of counterbalance springs 38 have respective upper ends attached to brackets 40 provided at the upper ends of the legs 16 and 18, and have respective lower ends respectively coupled to brackets 40 provided at lower rear regions of the header frame 36.

Formed integrally with the carrier frame 12 is a tongue support 42 that projects forwardly from, and is cantilever-mounted to, the transverse beam 14. The tongue support 42 includes a relatively broad base 44 having a right-hand end that is located approximately midway between the legs 16 and 18 of the frame 12. This location is dependent on the working width of the particular platform being used. The tongue support 42 includes a forward end which is located above a rear region of the header frame 36. Referring to FIG. 1, it can be seen that an angled tongue 46 includes a rear section 48, that constitutes approximately two-thirds of the length of the tongue, having a rear end pivotally coupled to a forward region of the tongue support 42 by a pin 50 establishing a vertical axis about which the tongue 46 may be swung. Joined to a forward end of the tongue rear section 48, so as to form an included angle of about 140°, is a rear end of a tongue front section 52 having a forward end connected, as at a coupling 54 (FIG. 2), to a drawbar 56 of a towing tractor 58. The sideways disposition of the tongue 46 relative to the tongue support 42 is controlled by an extensible and retractable tongue swing cylinder 60 that extends between, and has its opposite ends pivotally coupled to, a bracket 62 fixed to a middle left region of the tongue support 42, and an ear 64 formed at a left side location of the tongue 46 spaced forwardly of the tongue rear end. As shown in FIG. 1, the swing cylinder 60 is in a nearly fully retracted position wherein it disposes the front end of the tongue 46 at a location spaced sufficiently to the left of the mower-conditioner 10 that the tractor 58 is able to follow a path just to the left of standing crop which is to be cut by the mower-conditioner 10.

The mower-conditioner header 30 is equipped with a rotary cutterbar 66 (FIG. 2) disposed transversely across the header 30 and having a plurality of cutting units (not shown) mounted in spaced relationship to each other along a line of centers 68 (FIG. 1) across the length of the cutterbar, with the cutting units cooperating with crop converging drums (not shown) at opposite ends of the cutterbar so as to cause a narrowed stream of crop to be fed to a conditioning assembly (not shown), having a width less than that of the cutterbar and being mounted in a rear region of the header frame 36.

Power for driving the cutting units of the cutterbar 66, the crop converging drums and conditioning rolls, or an impeller rotor making up the conditioning assembly, is delivered by a main power distribution gearbox 70 having an input shaft 72, which is disposed at an angle of approximately 45° to an imaginary line extending straight ahead in the direction of travel. The gearbox 70 is mounted to a top wall of the header frame 36 at a location approximately in fore-and-aft alignment with the left-hand wheel 20, and slightly forward of the front end of the tongue support 42. A slip clutch assembly 73 is coupled to the input shaft 72

The tractor 58 is equipped with a power take-off shaft (not shown) for supplying the power for driving the driven mower-conditioner components, and this power take-off shaft is coupled to the main drive gearbox 70 by a driveline 74. The driveline 74, as considered from front to rear, includes a front telescopic shaft 76, a first pedestal shaft 78 carried by the tongue 46, a second pedestal shaft 80 carried by the tongue 46, a rear telescopic shaft 82, and the slip clutch assembly 73. All of the connections between the various shafts, and between the rear telescopic shaft 82 and the slip clutch assembly 73 are effected by single cardan joints, with a typical joint being shown at 84 in FIG. 3, and the shafting locations and angles are chosen so that a smooth delivery of power takes place.

As can be seen in FIG. 2, the tongue 46 and gearbox 70 are located at approximately the same height when the header 30 is fully raised, as shown, however, there is no interference between the tongue 46 and the header 30. While the lowered, operating position of the header 30 is not shown, it is to be understood that, when the header 30 is lowered for operation, there is ample space between the header 30 and the tongue 46 for the header 30 to float vertically without contacting the tongue 46.

Referring once again to FIG. 1, it can be seen that the relative positions of the tongue 46 and gearbox 70 are such that the tongue 46 may be swung between a maximum leftward position (this position is to the left of that shown and is achieved by fully contracting the swing cylinder 60), which is used, for example, when operating on a side hill with the header 30 up hill from the tractor 58, and a rightward transport position, which is achieved by fully extending the swing cylinder so that the front of the tongue 46 is located approximately centered in front of the header 30 so that the width of the header 30 is the transport width. Since the tongue 46 does not have to swing above the gearbox 70, the tongue does not have to be arched above the header 30. Such arching would require the tongue 46 to be attached at a location further to the rear that that used. The fact that the tongue support 42 projects a considerable distance forward has the beneficial result that the tongue 46 does not have to be as long and can be removed and easily transported with the mower-conditioner on a truck when it is being shipped from its point of manufacture.

Having described the preferred embodiment, it will become apparent that various modifications can be made without departing from the scope of the invention as defined in the accompanying claims.

1. In a side-pull mower-conditioner including a mobile frame, a header suspended from the mobile frame, a tongue mounted to the mobile frame for swinging about an upright axis between a working position, wherein a hitch connection at a front end of the tongue is positioned sufficiently leftward of a first path to be traveled by the header that a tractor can be coupled to the hitch connection and travel a second path leftward of said first path, a power distribution gear box mounted to said header and including an input shaft angled leftward from a line extending parallel to said first and second paths, and a driveline adapted for conveying power from said tractor to said gearbox, the improvement comprising: said driveline including, as considered from front to rear, a front telescopic shaft, front and rear pedestal shafts mounted to said tongue so as to be fixed in relationship to said tongue, and a rear telescopic shaft; a first single cardan joint being provided at the front of said front telescopic shaft; a second single cardan joint being provided between a rear of the front telescopic shaft and a front of said front pedestal shaft; a third single cardan joint being provided between a rear end of said front pedestal shaft and a front end of said rear pedestal shaft; a fourth single cardan joint connecting a rear end of said rear pedestal shaft and a front end of said rear telescopic shaft; and a fifth cardan joint being provided at a rear end of said rear telescopic shaft for transmitting power to said gearbox.

2. The side-pull mower conditioner, as defined in claim 1, wherein said tongue comprises front and rear sections coupled together to form an angle; and said rear telescopic shaft extending approximately parallel to said rear section of said tongue when said tongue is in said working position.
